(19) United States
(12) Patent Application Publication
(10) Pub. No.: US 2016/0141669 A1
(43) Pub. Date: May 19, 2016

(54) Pressure Compensation System Having a Safety Function for an Electrolytic Tank

(71) Applicant: GILDEMEISTER ENERGY STORAGE GMBH, Wiener Neudorf (AT)

(72) Inventors: MARTIN HARRER, WIEN (AT); PAUL BINDER, WIEN (AT); MICHAEL PINZL, BAD VÖSLAU (AT); ADAM WHITEHEAD, EISENSTADT (AT)

(73) Assignee: GILDEMEISTER ENERGY STORAGE GMBH, WIENER NEUDORF (AT)

(21) Appl. No.: 14/890,017

(22) PCT Filed: May 27, 2014
(86) PCT No.: PCT/EP2014/060984

§ 371 Date: Nov. 9, 2015

(30) Foreign Application Priority Data
Jun. 6, 2013 (AT) A50374/2013

(51) Int. Cl. H01M 8/04276; H01M 8/18

(52) U.S. Cl. CPC H01M 8/04276; H01M 8/188

(57) ABSTRACT

The invention relates to a pressure compensation system having a safety function for an electrolytic tank of flow batteries, in particular, vanadium redox flow batteries, and a head portion (5) of the electrolytic tank (3, 4) is connected to the surrounding area (2) of the flow battery via a pipeline (6), in which a primary bi-directional pressure compensation valve (7) is situated, and a bypass line (9, 20), in which a secondary bi-directional pressure compensation valve (10) having a second response pressure greater than the first response pressure is situated, branches off from the pipeline (6) having the primary pressure compensation valve (7) having a first response pressure, and the outlet (11) of said bypass line is situated within a housing (13) surrounding the electrolytic tanks (3, 4).

The present invention relates to a pressure compensation system having a safety function for an electrolytic tank of redox flow batteries, and a head portion of an electrolytic tank is connected with the surrounding area of the flow battery via a pipeline in which a primary bi-directional pressure compensation valve having a first response pressure is disposed.

It is known that redox flow batteries are made up of cells which are flown through by differently charged electrolytes. When using vanadium redox flow batteries, V²⁺ in the negative electrolyte converts to V³⁺ during discharging. Similarly, V⁵⁺ converts to V⁴⁺ in the positive electrolyte. This process is the normal electrochemical process as a consequence of the discharge, and the concentrations of V³⁺ in the negative electrolyte and V⁴⁺ in the positive electrolyte are, under normal conditions, approximately equal.

When the negative electrolytic liquid of such vanadium redox flow batteries comes in contact with oxygen, V²⁺ also converts to V³⁺ in the negative electrolyte. In this instance, an imbalance results between the negative electrolyte and the positive electrolyte which, in practice, results in a reduction of the available capacity.

While the electrolyte can be recycled, it is costly and associated with respective expenses. For this reason, the electrolyte is located in a sealed-off tank, and the sealed-off architecture of the electrolytic tank ensures that a chemical reaction with the oxygen from the surrounding air does not result.

As a consequence of the temperature change and gas formation during the charging process within the flow battery, there is, moreover, a tendency for a high pressure variation within the sealed-off electrolytic tank. Since, for obvious reasons, the electrolytic tank can only be safely operated within a certain pressure range, a respective compensation system is to be provided to ensure a safe function.

Within this context, the publication JP 2001093560A provides, for example, a system in which each area of the tank not including electrolytic fluid is filled with an inert gas. This filling of inert gas is kept at a constant pressure via a pressure control valve. In this instance, it is disadvantageous that the inert gas is to be checked in regular intervals and, if needed, to be replaced, which naturally entails additional expense and costs.

A further possibility to equalize pressure fluctuations within the electrolytic tank and, at the same time, to prevent that the electrolyte comes into contact with oxygen from the air, is to dispose flexible containers within the tank structure. Such a construction is, for example, shown in the publication U.S. Pat. No. 7,220515 BB or U.S. Pat. No. 6,681,789 BA. In this instance, the flexible containers are situated above the liquid stored in the tank and are in direct contact with the ambient air via respective openings. Depending on the pressure level within the electrolytic tank, the flexible containers are filled with more or less ambient air. For example, when the pressure level increases, the volume of the flexible container decreases, as a result of which the pressure within the electrolytic tank can be kept at a constant level owing to the released volume. A disadvantage is that, depending on the volume potential of the flexible containers, only a certain pressure difference can be equalized. For that instance when the opening, via which the flexible container is connected with the surrounding area, is displaced or clogged, a safety device is not provided. For this reason, such a blocking of the main outlet would result in a failure of the pressure compensation system.

The publication CN 102244281A shows an indirect seal assembly in which the tank of a flow battery is sealed off from the surrounding area by using a seal liquid or a seal gas so that oxygen from the air does not get into the interior of the electrolytic tank. In this instance, the seal liquid is located in the sink of a pipeline, the shape of which equates to a horizontal “S.” On the one hand, this pipeline runs into the head portion of the electrolytic tank and, on the other hand, directly into the surrounding area. The disadvantage of the shown embodiment is that no safety devices are provided for the case of a malfunctioning, for example, for the case of an already mentioned blockage of the pipeline.

The object of the present invention is to design a bi-directional pressure compensation system for electrolytic tanks of flow batteries constructed as simply as possible which, under all circumstances, is to ensure a safe function and which furthermore ensures that the electrolytic liquids are separated from the oxygen of the surrounding air.

According to the present invention, this object is achieved by a pressure compensation system of the art mentioned at the outset in that a bypass branches off from the pipeline, in which a secondary bi-directional pressure compensation valve having a second response pressure being greater than the first response pressure is situated, and a valve outlet of the bi-directional pressure compensation valve is located within a housing surrounding the electrolytic tank. In this instance, it is insignificant from which location of the pipeline the bypass branches off. For example, if the main outlet on the ambient side of the primary bi-directional pressure compensation valve is displaced or blocked as a consequence of snow, foliage, dirt, etc. or other influences such as vandalism, the secondary bi-directional pressure compensation valve, protected by the surrounding housing, ensures that the accumulated gas nevertheless escapes at an appropriate pressure difference.

The response pressure, thus, the value for the mentioned pressure difference between the head portion of the electrolytic tank and the surrounding area where the exhausting of the formed gases via the secondary bi-directional pressure compensation valve occurs, lies, according to the present invention, above the response pressure at which the primary bi-directional pressure compensation valve is activated and is typically selected as a function of the structural features of the electrolytic tank to prevent them from being damaged.

Since the gas formed within the electrolytic tank during the charging is flammable owing to its high content of hydrogen, a flashback valve is advantageously situated at the main outlet. In doing so, it may be prevented that, in the case of an ignition of the escaping gas, the flames may flash back into the interior of the housing.

A sensor for detecting escaping gas is advantageously situated in the area of the valve outlet of the secondary bi-directional pressure compensation valve. This enables to detect a pressure difference which is sufficiently great so that the gas is able to take the path via the bypass line and not via the primary bi-directional pressure compensation valve. Consequently, a possible malfunctioning of the primary bi-directional pressure compensation valve may be concluded. Furthermore, the flow battery, for example, may be separated from the electric network of the photovoltaic or wind power system to stop the further gas formation in the course of the charging process. In doing so, the formation of a critical concentration of gas within the housing surrounding the electrolytic tank could also be prevented. Furthermore, an appropriate output informing the operator of the flow battery about the malfunctioning and, thus, initiating an appropriate action is also conceivable.

An advantageous embodiment of the present invention provides that the secondary bi-directional pressure compensation valve is formed by a U-shaped bypass line which is filled with a certain volume of seal liquid and the seal liquid is disposed in the sink of the U-shaped bypass line in a pressure balanced state. For this reason, a simply constructed valve, which may be easily adapted to different response pressures via the amount of seal liquid, may be realized without using movable mechanics susceptible to servicing, and it is here again insignificant at which location of the pipeline the U-shaped bypass branches off.

In an advantageous manner, it may be furthermore provided that the primary bi-directional pressure compensation valve is formed by a U-shaped pipe section of the pipeline, which connects the head portion of the electrolytic tank with the surrounding area of the tank, and in the pressure balanced state a seal liquid is disposed in the sink of the U-shaped bypass line, and the advantageous effect is analogous to the effect of the secondary bi-directional pressure compensation valve just described.

Within this context, it is advantageously provided that the seal liquid is a liquid having a low evaporation rate such as mineral oil or paraffin oil. In doing so, the response pressure or the mentioned pressure difference at which a pressure equalization starts to result may be kept nearly constant because no significant loss of the seal liquid, as a consequence of evaporation, occurs.

A further advantageous embodiment provides that an anti-static liquid is used as seal liquid or that an anti-static additive is added to the seal liquid.

In a further advantageous manner, an acoustic sensor is disposed at the U-shaped bypass line. if gas bubbles pass through the seal liquid disposed in the U-shaped bypass line, a characteristic acoustic signal is generated which is detected by the acoustic sensor, Again, a possible blockage or malfunction of the primary bi-directional pressure compensation valve may be consequently concluded.

In order to facilitate the filling and the servicing, the U-shaped pipe section and/or the U-shaped bypass line is/are advantageously designed in a transparent or translucent manner.

In a very similar advantageous embodiment, an optical sensor is situated at the U-shaped bypass line in lieu of or besides the acoustic sensor, and said pipeline is designed in a transparent or translucent manner. As soon as gas bubbles, which are located in the U-shaped bypass line, pass through the seal liquid, a momentary change of the optical signal results. This change is to be understood as an indication that the primary bi-directional pressure compensation valve does not function according to specifications.

A further advantageous embodiment provides that a flushing valve is provided between the net and outlet side of the primary bi-directional pressure compensation valve, This enables, for example, when flushing with a flushing gas for servicing purposes, a higher gas flow rate than easible by way of primary bi-directional pressure compensation valve 7.

In order to increase the service life of the pressure compensation system, it is advantageously provided that the U-shaped pipe section and the bypass line are, vis-à-vis the electrolytic fluids, made of a chemically resistant material because electrolytic liquid in form of droplets may quite possibly be located inside of the formed gas.

An advantageous embodiment of the present invention includes that a device for grounding is provided which is in electrical contact with the seal liquids. This enables to lower the risk of static charging.

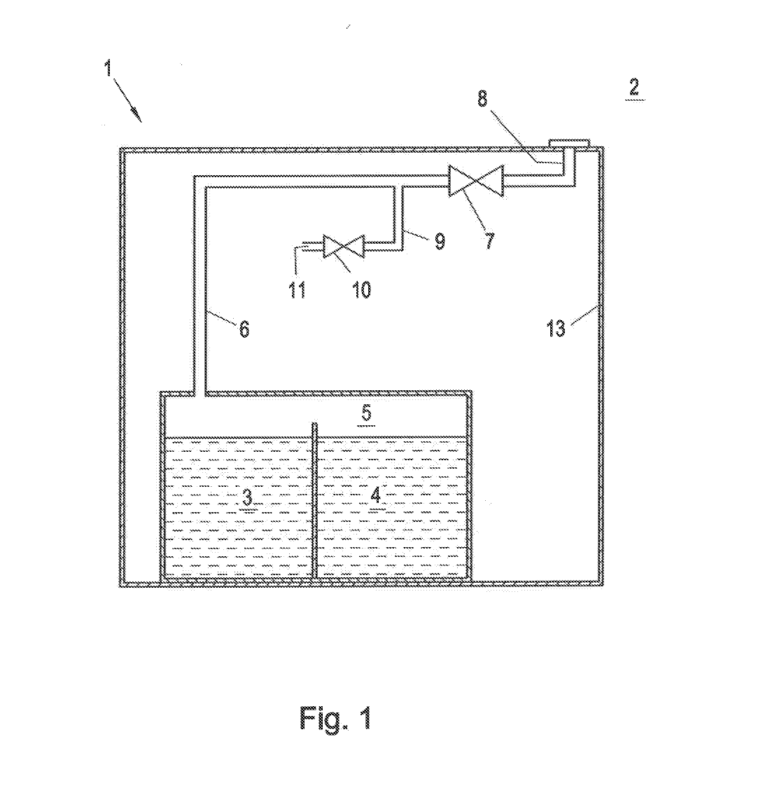

The present invention is subsequently described in more detail in reference to FIGS. 1 through 3 which show advantageous embodiments of the present invention in an exemplary, schematic and non-limiting manner.

FIG. 1 shows the schematic structure of the tank area of a flow battery including a pressure compensation system having a safety function according to the present invention;

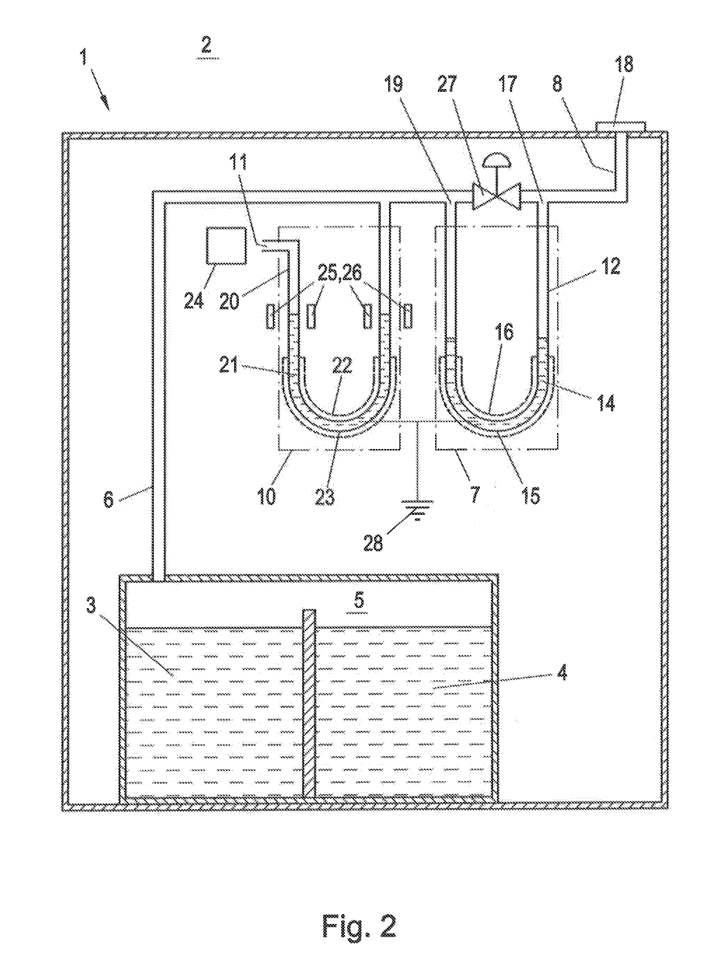

FIG. 2 shows the schematic structure of the tank area of a flow battery including a pressure compensation system having a safety function according to the present invention in a particularly advantageous embodiment; and

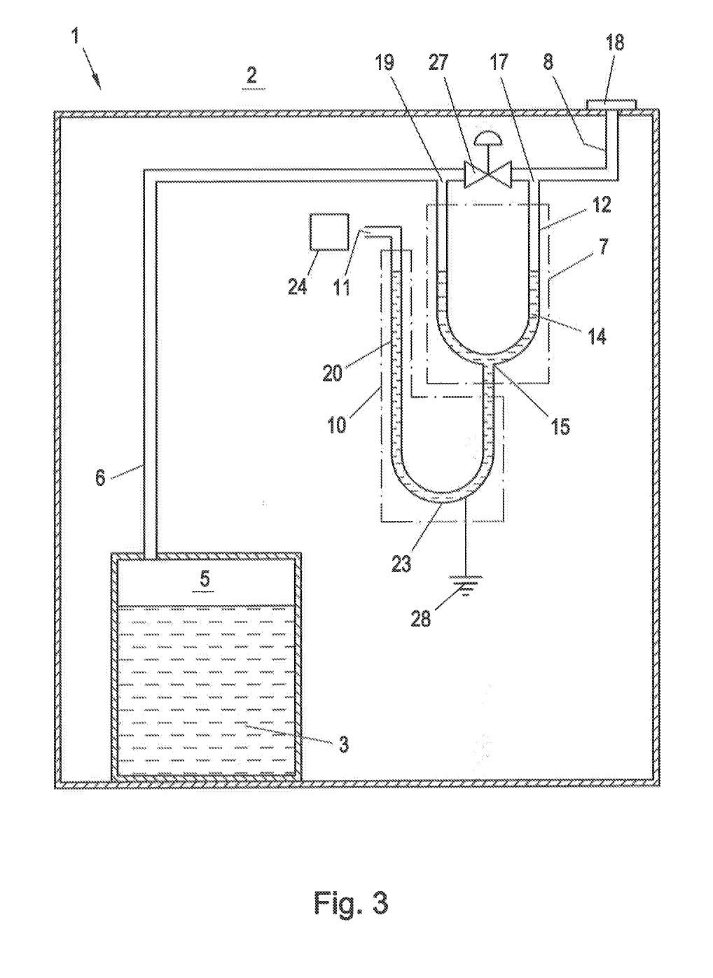

FIG. 3 shows the schematic structure of the pressure compensation system in a further layout variation.

FIG. 1 shows the schematic structure of tank area of a flow battery according to the present invention in which two electrolytic tanks 3 and 4 have a common head portion 5; however, an architecture in which each of the two electrolytic tanks 3 and 4 has its own head portion 5 lying above is &so conceivable, and, in this case, each head portion is connected to the pressure compensation system according to the present invention,

Subsequently, only one common head portion 5 is mentioned in a non-limiting manner.

The gas generated, for example, through heating accumulates in common head portion 5 of two electrolytic tanks 3 and 4. Via a pipeline 6 and primary bi-directional pressure compensation valve 7, the formed gas may escape at an appropriate pressure difference via main outlet 8 in housing 13 into the surrounding area.

Furthermore, bypass line 9 having a secondary bi-directional pressure compensation valve 10 branches off pipeline S.

When the pressure increases by way of an increased gas evolution in head portion 5, for example, owing to operational heating, the accumulated gas may escape via main outlet 8 on the ambient side of primary bi-directional pressure compensation valve 7 into surrounding area 2. The response pressure of the primary bi-directional pressure compensation valve 7, thus, the necessary pressure difference between head portion 5 and surrounding area 2, is a function of the setting or the dimensioning of primary bi-directional pressure compensation valve 7.

If primary bi-directional pressure compensation valve 7 is not functional, for example, as a consequence of a blockage of main outlet 8 on the ambient side, the pressure difference between head portion 5 and primary bi-directional pressure compensation valve 7 further increases as a consequence of the sustained gas evolution, When the pressure difference reaches a respective level, namely the response pressure of secondary bi-directional pressure compensation valve 10. the gas is exhausted via secondary bi-directional pressure compensation valve 10, and the gas escapes via valve outlet 11 which, according to the present invention, is situated inside the housing of electrolytic tanks 3 and 4. The level of the response pressure at which the gas is exhausted via secondary bi-directional pressure compensation valve 10 lies above the pressure difference at which primary bi-directional pressure compensation valve 7 enables, in normal operation, the gas to escape via main outlet 8 on the ambient side and is typically a function of the structural features of electrolytic tanks 3 and 4. Owing to that the response pressure of secondary bi-directional pressure compensation valve 10 lies above the response pressure of primary bi-directional pressure compensation valve 7, it is ensured that the pressure compensation in normal operation occurs exclusively via primary bi-directional pressure compensation valve 7.

Since the described mode of action is bi-directional, an underpressure in head portion 5, potentially resulting as a consequence of atmospheric changes, may also be equalized in the same manner.

FIG. 2 shows just-described tank area 1 of a flow battery according to the present invention in a particularly advantageous embodiment.

In this instance, the primary bi-directional pressure compensation valve 7 is formed by a U-shaped pipe section 12 of pipeline 6 which connects head portion 5 of electrolytic tanks 3 and 4 with surrounding area 2 of tank area 1. In the pressure balanced state, a seal liquid 14 is located in sink 16 of this U-shaped pipe section 12.

The increase of pressure in head portion 5 of two electrolytic tanks 3 and 4 as a consequence of an increased gas evolution, for example, owing to operational heating, seal liquid 14 is displaced within U-shaped pipe section 12 in the direction of outlet side 17, As soon as the response pressure of primary bi-directional pressure compensation valve 7 is reached, thus, the pressure difference is sufficient to push seal liquid 14 completely above outer dead center 15 of U-shaped pipe section 12, the accumulated gas in the form of individual, rising gas bubbles may escape through U-shaped pipe section 12, seal liquid 14 therein included and, finally, via outlet side 17 through main outlet 8 on the ambient side and flashback valve 18, as a result of which the resulting pressure difference is successively reduced. The escape process continues until seal liquid 14 moves again, as a consequence of the reducing pressure difference, in the area of outer dead point 15 of U-shaped pipe section 12.

Since the described mode of action is bi-directional, an underpressure in head portion 5 potentially resulting in isolated cases may also be equalized in the same manner. In this instance, seal liquid 14 is however displaced within U-shaped pipe section 12 in the direction of inlet 19 on the tank side of U-shaped pipe section 12. For this reason, as soon as seal liquid 14 is located completely above outer dead point 15 of U-shaped pipe section 12, ambient air may be, in the form of individual gas bubbles, taken in through U-shaped pipe section 12 and seal liquid 14 included therein in the same manner as already described, as a result of which the resulting pressure difference in turn is reduced. Similarly to when overpressure is reduced, the intake process when an underpressure is present continues until seal liquid 14 moves again, as a consequence of the reducing pressure difference, in the area of outer dead point 15 of U-shaped pipe section 12.

The response pressure, thus, the mentioned pressure difference between head portion 5 and surrounding area 2, which is necessary to push seal liquid 14 completely above outer dead center 15 of U-shaped pipe section 12, is a function of the dimensioning of U-shaped pipe section 12, the type of seal liquid 14 and the amount of said seal liquid and may be, in this manner, simply adjusted.

Likewise, secondary bi-directional pressure compensation valve 10 is designed in the form of U-shaped bypass line 20 having seal liquid 21, which is situated in the pressure balanced state in sink 22 of U-shaped bypass line 20. U-shaped bypass line 20 is shown in an exemplary manner on the tank side of U-shaped pipe section 12.

If primary bi-directional pressure compensation valve 7 is not functional, for example, as a consequence of a blockage of main outlet 8 on the ambient side, the pressure difference between head portion 5 of two electrolytic tanks 3 and 4 and primary bi-directional pressure compensation valve 7 further increases as a consequence of the sustained gas evolution until the response pressure of secondary bi-directional pressure compensation valve 10 is reached. As described for primary bidirectional pressure compensation valve 7, seal liquid 21 is, for this reason, displaced in the same manner within U-shaped bypass line 21. As soon as seal liquid 21 is located completely above outer dead point 23 of U-shaped bypass line 20, the accumulated gas in the form of individual, rising gas bubbles may escape through U-shaped bypass line 20 and seal liquid 21 therein included and subsequently via valve outlet 11, which according to the present invention is located within housing 13 surrounding electrolytic tanks 3 and 4. As described for primary bi-directional pressure compensation valve 7, the escape process continues until seal liquid 21 moves again, as a consequence of the reducing pressure difference, in the area of outer dead point 23 of U-shaped bypass line 20.

Sensor 24, situated in the area of valve outlet 11, detects a possible discharge of gas via U-shaped bypass line 20, Since, in doing so, a possible malfunctioning of primary bi-directional pressure compensation valve 7 may be concluded, the flow battery may be, for example, separated from the electric network of the photovoltaic or wind power system to stop the further gas formation in the course of the charging process and/or to inform the operator of the flow battery about the malfunctioning by an appropriate output.

Furthermore, acoustic sensors 25 and/or optical sensors 26 may be disposed at U-shaped bypass line 20, which detect(s) the displacement of seal liquid 21 or the passing-through of gas bubbles.

As for primary bi-directional pressure compensation valve 7, the level of the required pressure difference or the level of the response pressure is a function of the dimensioning of U-shaped bypass line 20, the type of seal liquid 21 and the amount of said seal liquid, and the necessary pressure difference for activating secondary bi-directional pressure compensation valve 10 is, as has been described, higher than for primary bi-directional pressure compensation valve 7. The level of the necessary pressure difference for activating secondary bi-directional pressure compensation valve 10 may, as also already described, also become a function of the structural features of electrolytic tanks 3 and 4.

The bi-directional action and the mode of function connected therewith are also similar to those of primary bi-directional pressure compensation valve 7.

Between inlet side 19 and outlet side 17 of primary bi-directional pressure compensation valve 7, a flushing valve 27 may be provided. In normal operation, flushing valve 27 is sealed and the resulting gas takes, as described, at a sufficient pressure difference the path through primary bi-directional pressure compensation valve 7 or seal liquid 14 included therein. Flushing valve 27 in the open position enables the flushing for servicing purposes by way of a flushing gas having a higher gas flow rate than feasible by way of primary bi-directional pressure compensation valve 7.

A grounding of seal liquids 14 and 21 by way of device 28 ensures that the risk of static charging is reduced to a minimum. This risk may of course also be minimized by using anti-static seal liquids or by mixing in an anti-static additive to seal liquids 14 and 21.

FIG. 3 shows the schematic structure of the pressure compensation system in a further layout variation in which only one electrolytic tank 3 is disposed and U-shaped bypass line 20 branches off from outer dead point 15 of U-shaped pipe section 12 of pipeline 6.

The relation between the first response pressure of primary bi-directional pressure compensation valve 7 and the second response pressure of secondary bi-directional pressure compensation valve 10 is a function of their arrangement or their position to each other. Otherwise, the function is identical to the embodiment in FIG. 2.

1. A pressure compensation system having a safety function for an electrolytic tank of redox flow batteries, wherein a head portion of an electrolytic tank is connected with the surrounding area of the flow battery via a pipeline in which a primary bi-directional pressure compensation valve having a first response pressure is situated, wherein a bypass line, in which a secondary bi-directional pressure compensation valve having a second response pressure, which is greater than the first response pressure, is situated, branches off from the pipeline and a valve outlet of the secondary bi-directional pressure compensation valve is located within a housing surrounding the electrolytic tank.

2. The pressure compensation system according to claim 1, wherein a flashback valve situated at a main outlet.

3. The pressure compensation system according to claim 1, wherein a sensor is located in the area of the valve outlet of the secondary bi-directional pressure compensation valve for detecting escaping gas.

4. The pressure compensation system according to claim 1, wherein the secondary bi-directional pressure compensation valve is formed by a U-shaped bypass line filled with a certain amount of seal liquid and the seal liquid is disposed in the pressure balanced state in the sink of the U-shaped bypass line.

5. The pressure compensation system according to claim 1, wherein the primary bi-directional pressure compensation valve is formed by a U-shaped pipe section of the pipeline which connects the head portion of the electrolytic tanks with the surrounding area of a tank area and a seal liquid is situated in the pressure balanced state in the sink of the U-shaped pipe section.

6. The pressure compensation system according to claim 1, wherein the seal liquid is provided with a liquid having a reduced evaporation rate.

7. The pressure compensation system according to claim 1, wherein an anti-static liquid is used as seal liquid or that an anti-static additive is added to the seal liquid.

8. The pressure compensation system according to claim 1, wherein an acoustic sensor is disposed at the U-shaped bypass line.

9. The pressure compensation system according to claim 1 wherein the U-shaped pipe section and/or the U-shaped bypass line is/are designed in a transparent or translucent manner.

10. The pressure compensation system according to claim 1, wherein an optical sensor is disposed at the U-shaped bypass line and the U-shaped bypass line is designed in a transparent or translucent manner.

11. The pressure compensation system according to claim 1, wherein a flushing valve is provided between inlet side and outlet side of the primary pressure compensation valve.

12. The pressure compensation system according to claim 1, wherein the U-shaped pipe section and the bypass line are made out of chemically resistant material vis-à-vis the electrolytic fluid in the electrolytic tank.

13. The pressure compensation system according to claim 1, wherein a device for grounding is provided which is in electrical contact with the seal liquid.
